(19) United States
(12) Patent Application Publication
(10) Pub. No.: US 2026/0179007 A1
(43) Pub. Date: Jun. 25, 2026

(54) INFORMATION PROCESSING APPARATUS, INFORMATION PROCESSING METHOD, AND COMPUTER PROGRAM PRODUCT

(71) Applicant: KABUSHIKI KAISHA TOSHIBA, Tokyo (JP)

(72) Inventors: Takufumi YOSHIDA, Funabashi Chiba (JP); Yacheng WANG, Shinjuku Tokyo (JP)

(73) Assignee: KABUSHIKI KAISHA TOSHIBA, Tokyo (JP)

(21) Appl. No.: 19/267,748

(22) Filed: Jul. 14, 2025

(30) Foreign Application Priority Data
Dec. 19, 2024 (JP) 2024-223716

(51) Int. Cl. G06Q 10/0631

(52) U.S. Cl. CPC G06Q 10/06312

(57) ABSTRACT

An information processing apparatus includes a hardware processor. The hardware processor calculates, for an initial schedule including a resource allocated to a task included in jobs and a finish date/time of the task, a corrected finish date/time obtained by correcting a finish date/time by using correction information defined for the jobs. The hardware processor determines, by using a corrected finish date/time, a provision destination candidate that is a candidate for a task of receiving provision of a resource and a provision source candidate that is a candidate for a task of providing a resource. The hardware processor generates a provision candidate including a provision source resource allocated to the provision source candidate and the provision destination candidate. The hardware processor generates a changed schedule for which the initial schedule is changed by optimizing resource allocation to the task included in the jobs by using the provision candidate.

### CROSS-REFERENCE TO RELATED APPLICATIONS

This application is based upon and claims the benefit of priority from Japanese Patent Application No. 2024-223716, filed on Dec. 19, 2024; the entire contents of which are incorporated herein by reference.

### FIELD

Embodiments described herein relate generally to an information processing apparatus, an information processing method, and a computer program product.

### BACKGROUND

For example, in order to improve efficiency of work such as picking and boxing in a distribution warehouse, a technique of generating a schedule for which resources such as workers and robots are allocated to tasks (corresponding to works) included in a plurality of jobs has been proposed. In the generated schedule, the resource allocation may be desirable to change according to the progress status of the task, the capability of the resource, and the like.

For example, in accordance with the progress status of each job included in the generated schedule (initial schedule), the progress status of a plurality of jobs can be leveled by allocating a resource allocated to a job whose work is advanced to a job whose work is delayed.

### BRIEF DESCRIPTION OF THE DRAWINGS

FIG. 1 is a block diagram of an information processing apparatus according to a first embodiment;

FIG. 2 is a flowchart of a re-scheduling process according to the embodiment;

FIG. 3 is a diagram illustrating a calculation example of corrected finish date and time;

FIG. 4 is a diagram illustrating a calculation example of corrected finish date and time; and

FIG. 5 is a hardware configuration diagram of the information processing apparatus according to the embodiment.

### DETAILED DESCRIPTION

An object of the present disclosure is to provide an information processing apparatus, an information processing method, and a computer program product capable of more efficiently executing re-scheduling for changing a generated schedule.

Hereinafter, a preferred embodiment of an information processing apparatus according to the present disclosure will be described in detail with reference to the accompanying drawings. The present disclosure is not limited to the following embodiments.

The embodiment can be applied to scheduling of an object (work, process, and operation) as follows, but applicable scheduling is not limited thereto. For example, the present embodiment can be applied to any scheduling as long as the scheduling is for an object for which the allocated resource can be changed.

### Application Example 1

Object: a work such as picking and boxing at distribution warehouse
Resource: a worker (person), a robot, etc.

### Application Example 2

Object: processes executed by computer
Resource: hardware used in a computer such as a processor, a memory, and a communication line

A schedule includes a plurality of jobs. A job includes one or more tasks. A resource is allocated for each task. Re-scheduling corresponds to generation of a schedule (changed schedule) for which a resource allocated to a task of a certain job included in an initial schedule is changed to be re-allocated to a task of another job.

Hereinafter, the provision (allocation) of resources may be referred to as support. In addition, a resource providing source may be referred to as a support source, and a resource providing destination may be referred to as a support destination. For example, receiving the provision of the resource corresponds to receiving the support. Furthermore, providing a resource corresponds to giving support. Generating the changed schedule can also be interpreted as corresponding to generating a support schedule (support schedule).

In the re-scheduling, if the support is too active, a delay may occur in the job including the task of the support source. On the other hand, if it is too conservative, there may be less support and the progress cannot be leveled in some cases. Therefore, it is desirable to appropriately adjust the frequency of support.

In the present embodiment, the changed schedule is generated by appropriately controlling the frequency of receiving support from other jobs and the frequency of providing support to other jobs. As a result, the re-scheduling can be executed more efficiently. In addition, it is possible to generate a changed schedule that is more easily accepted to the site.

For example, the information processing apparatus according to the embodiment has the following functions.
(F1) A function of generating a changed schedule for which an allocation of a certain resource is changed to a task of another job with respect to an initial schedule for which a resource is allocated to each task of a plurality of jobs
(F2) A function of calculating a corrected finish date and time for each task by using correction information indicating easiness of support and a closing date and time that is a finish date and time for each job, comparing the finish date and time for each task in the initial schedule or the changed schedule with the corrected finish date and time, and determining a candidate of a task as a support destination (support destination candidate and provision destination candidate) and a candidate of a task as a support source (support source candidate, provision source candidate)

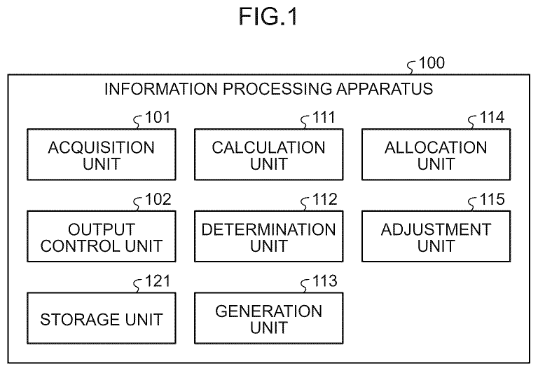

FIG. 1 is a block diagram illustrating an example of a configuration of an information processing apparatus 100 according to a first embodiment. As illustrated in FIG. 1, the information processing apparatus 100 includes a storage unit 121, an acquisition unit 101, an output control unit 102, a calculation unit 111, a determination unit 112, a generation unit 113, an allocation unit 114, and an adjustment unit 115.

The storage unit 121 controls various types of information used in the information processing apparatus 100. For example, the storage unit 121 stores information acquired by the acquisition unit 101, processing results by other units, and the like.

Note that the storage unit 121 can be configured by any commonly used storage medium such as a flash memory, a memory card, a random access memory (RAM), a hard disk drive (HDD), and an optical disc.

The acquisition unit 101 acquires various types of information used in the information processing apparatus 100. For example, the acquisition unit 101 acquires the following information. A method of acquiring information by the acquisition unit 101 may be any method, and for example, a method of receiving information from an external device via a network, a method of reading information from a storage medium, or the like can be applied.
Initial schedule
Correction information
resource capability information

The initial schedule includes, for example, the following information.
Closing date and time for each of a plurality of jobs
Scheduled finish date and time of each of one or more tasks included in each of the plurality of jobs (for example, the target date and time when the initial schedule is generated)
Finish date and time of each of one or more tasks (for example, the finish date and time of the result of allocation calculation using the scheduled finish date and time)
Resource allocated to each of one or more tasks

The initial schedule may be generated in any manner. In a case where the initial schedule is generated by an external device of the information processing apparatus 100, the acquisition unit 101 acquires the initial schedule from the external device.

The correction information is information indicating easiness of support, and is defined for each of the plurality of jobs. The correction information may be divided into two types, that is, correction information IA (first correction information) that is defined such that a larger value is more likely to receive provision of a resource (support), and correction information IB (second correction information) that is defined such that a smaller value is more likely to provide a resource. The correction information IA corresponds to information for adjusting the frequency of receiving support from another job. The correction information IB corresponds to information for adjusting the frequency of giving support to another job.

Note that in one configuration, one piece of correction information having functions of both the correction information IA and the correction information IB may be used. In this configuration, both the correction information IA and the correction information IB described below may be interpreted as representing one piece of correction information.

The capability information of resource is, for example, the following information.
Types of tasks that can be processed
Processing time or processing speed for each task

The calculation unit 111 calculates a corrected finish date and time obtained by correcting the finish date and time of the task using the correction information. For example, the calculation unit 111 calculates a corrected finish date and time obtained by correcting the finish date and time using the correction information of each of one or more tasks with respect to the initial schedule.

The correction information IA and the correction information IB will be described separately. For example, the calculation unit 111 calculates a corrected finish date and time ETA (first correction finish date and time) obtained by correcting the finish date and time using the correction information IA. The correction finish date and time ETA corresponds to a corrected finish date and time in a case where provision of resources is assumed to be received. In addition, the calculation unit 111 calculates a corrected finish date and time ETB (second corrected finish date and time) obtained by correcting the finish date and time using the correction information IB. The corrected finish date and time ETB corresponds to a corrected finish date and time in a case where a resource is assumed to be provided.

A method of calculating the corrected finish date and time will be further described. First, the calculation unit 111 calculates a corrected closing date and time obtained by correcting the closing date and time of the job by the correction information of the job. Next, the calculation unit 111 calculates the corrected finish date and time such that one or more tasks finish by the corrected closing date and time. For example, the calculation unit 111 calculates the corrected finish date and time such that the ratio of the scheduled finish date and time of each of one or more tasks included in the job matches the ratio of the corrected finish date and time of each of one or more tasks. Details of the method of calculating the corrected finish date and time will be described later.

The determination unit 112 determines a support destination candidate (provision destination candidate) and a support source candidate (provision source candidate) by using the calculated corrected finish date and time. The support destination candidate represents a candidate of a task that is to receive a resource from a task included in another job. The support source candidate represents a candidate of a task that is to provide a resource to a task included in another job.

For example, the determination unit 112 assesses the progress of the task by comparing the finish date and time with the corrected finish date and time ETA for each task, and determines a task whose progress is delayed as a support destination candidate. Furthermore, the determination unit 112 assesses the progress of the task by comparing the finish date and time with the corrected finish date and time ETB for each task, and determines a task whose progress is advanced as a support source candidate.

The generation unit 113 generates one or more support candidates (provision candidates) including a support source resource (provision source resource) that is a resource allocated to a support source candidate (provision source candidate) and a support destination candidate (provision destination candidate).

The allocation unit 114 generates the changed schedule by executing an optimization process of optimizing the allocation of resources to one or more tasks included in each of the plurality of jobs using the support candidates. For example, the allocation unit 114 executes the optimization process so as to minimize the finish date and time of each of the plurality of jobs.

The adjustment unit 115 is a function for adjusting the correction information. For example, the adjustment unit 115 adjusts the correction information based on a comparison result between the generated changed schedule and the schedule adopted on the basis of the changed schedule.

The output control unit 102 controls output of various types of information used in the information processing apparatus 100. For example, the output control unit 102 outputs the generated changed schedule to an external device (system) or the like that uses the changed schedule. The information output method may be any method, and for example, a method of displaying on a display device, a method of transmitting information to an external device via a network, and the like can be applied.

At least a part of each unit (acquisition unit 101, output control unit 102, calculation unit 111, determination unit 112, generation unit 113, allocation unit 114, and adjustment unit 115) may be realized by one or more processing units. Each of the above units is realized by, for example, one or a plurality of processors. For example, each of the above units may be realized by causing a processor such as a central processing unit (CPU) and a graphics processing unit (GPU) to execute a program, that is, by software. Each of the above units may be realized by a processor such as a dedicated integrated circuit (IC), that is, hardware. Each of the above units may be realized by using software and hardware in combination. When a plurality of processors is used, each processor may implement one of the units or two or more of the units.

The information processing apparatus 100 may be physically configured by one apparatus or may be physically configured by a plurality of apparatuses. For example, the information processing apparatus 100 may be constructed on a cloud environment. Furthermore, each unit in the information processing apparatus 100 may be dispersedly provided in a plurality of apparatuses.

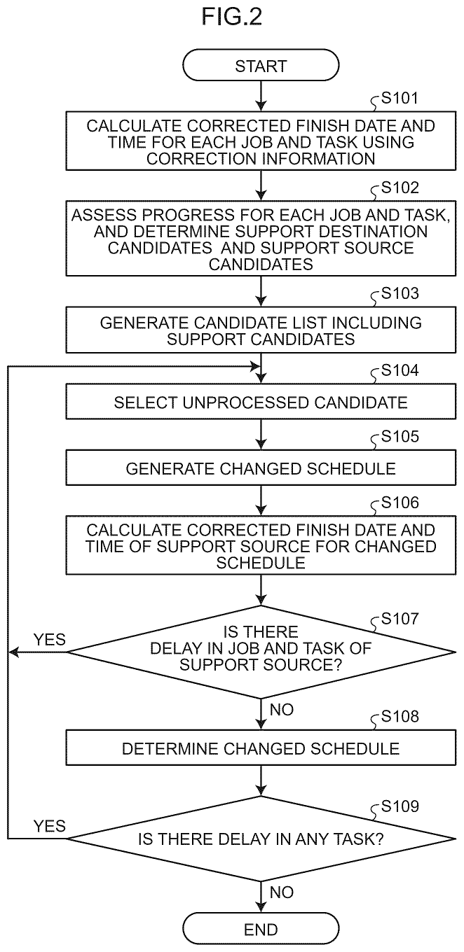

Next, a re-scheduling process by the information processing apparatus 100 according to the embodiment will be described. FIG. 2 is a flowchart illustrating an example of a re-scheduling process according to the embodiment. It is assumed that necessary information such as an initial schedule, correction information, and resource capability information is acquired by the acquisition unit 101 before the re-scheduling process.

The calculation unit 111 calculates the corrected finish dates and times ETA and ETB for each job and each task included in the initial schedule by using the correction information IA and IB (step S101).

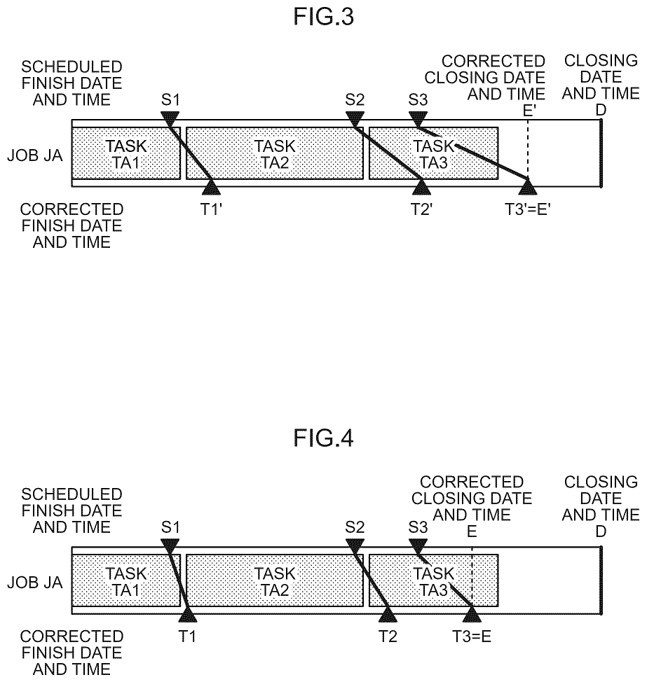

Details of the method of calculating the corrected finish date and time will be described with reference to FIGS. 3 and 4. FIG. 3 is a diagram for describing an example of a method of calculating the corrected finish date and time ETA in a case where the provision of the resource is received. FIG. 4 is a diagram for describing an example of a method of calculating the corrected finish date and time ETB in a case where the resource is provided.

FIGS. 3 and 4 illustrate calculation examples of corrected finish date and time for one job JA. The corrected finish date and time is calculated for each of the plurality of jobs included in the initial schedule in a procedure similar to that in FIGS. 3 and 4. In addition, FIGS. 3 and 4 illustrate an example in which the job includes three tasks. The number of tasks included in the job is not limited to three, and may be one, two, or four or more.

As illustrated in FIG. 3, scheduled finish date and time (S1, S2, and S3) is set for each of three tasks TA1 to TA3 included in the job JA. In addition, the final closing date and time D is set for the job JA. The correction information IA is given to the job JA in order to calculate the corrected finish date and time ETA in a case where the support is received.

First, the calculation unit 111 calculates the corrected closing date and time E′ by the following equation.

$${E}^{′} = ( 1 - correction information IA ) \times D$$

In the case of using the above equation, the correction information IA takes a real value of 0 or more and 1 or less. If the value of the correction information IA gets higher, the value of the corrected closing date and time E′ gets smaller. In other words, the corrected closing date and time E′ is a value representing an earlier date and time. Therefore, there is a high possibility that the task will not be finished by the corrected closing date and time E′, and the provision of the resource (support) is easily received.

The correction information IA is not limited to the information taking the above value. Contrary to the above format, the correction information IA may be defined such that the smaller value is more likely to receive the provision of the resource (support). In this case, the corrected closing date and time E′ may be calculated by the following equation.

$${E}^{′} = correction information IA \times D$$

Next, the calculation unit 111 sets the corrected finish date and time T3′ of the task TA3 as the corrected closing date and time E′. In addition, the calculation unit 111 calculates the corrected finish dates and times T1′ and T2′ of the tasks TA1 and TA2 by the following equation using the scheduled finish dates and times S1, S2, and S3 and the corrected finish date and time T3′ of each task.

$$T {1}^{′} : T {2}^{′} : T {3}^{′} = S 1 : S 2 : S 3$$

Thus, the calculation unit 111 calculates the corrected finish date and time such that the ratio of the scheduled finish date and time of each of one or more tasks matches the ratio of the corrected finish date and time of each of one or more tasks.

Next, with reference to FIG. 4, an example of a method of calculating the corrected finish date and time ETB in a case where the resource is provided will be described. The correction information IB is given to the job JA in order to calculate the corrected finish date and time ETB in a case where the resource is provided (the support is given).

The method of calculating the corrected finish date and time ETB is substantially similar to the method of calculating the corrected finish date and time ETA. First, the calculation unit 111 calculates the corrected closing date and time E by the following equation.

$$E = ( 1 - correction information IB ) \times D$$

In the case of using the above equation, the correction information IB takes a real value of 0 or more and 1 or less. If the value of the correction information IB gets smaller, the value of the corrected closing date and time E gets larger. In other words, the corrected closing date and time E is a value representing a later date and time. Therefore, there is a high possibility that the task will be finished by the corrected closing date and time E, and the provision of the resource (support) is easily realized.

The correction information IB is not limited to the information taking the above value. Contrary to the above format, the correction information IB may be defined such that the larger value is more likely to provide the resource (support). In this case, the corrected closing date and time E may be calculated by the following equation.

$$E = correction information IB \times D$$

Next, the calculation unit 111 sets the corrected finish date and time T3 of the task TA3 as the corrected closing date and time E. In addition, the calculation unit 111 calculates the corrected finish dates and times T1 and T2 of the tasks TA1 and TA2 by the following equation using the scheduled finish dates and times S1, S2, and S3 and the corrected finish date and time T3 of each task.

$$T 1 : T 2 : T 3 = S 1 : S 2 : S 3$$

The description returns to FIG. 2. The determination unit 112 assesses the progress for each job and each task, and determines support destination candidates and support source candidates using the assessed progress (step S102).

An example of FIG. 3 will be described. For example, the determination unit 112 assesses whether or not the finish date and time of each task (finish date and time included in the initial schedule) satisfies the following condition for the job JA.
Finish date and time of task TA1>corrected finish date and time T1′
Finish date and time of task TA2>corrected finish date and time T2′
Finish date and time of task TA3>corrected finish date and time T3′

If at least one of the above three conditions is satisfied, the determination unit 112 assesses that the progress of the job JA is delayed, that is, the job JA needs to receive support. Note that the assessment as to whether the progress is delayed is not limited to the above method. For example, in a case where the number of tasks included in the job JA is k, the determination unit 112 may assess that the progress of the job JA is delayed when j (j is an integer of 1 or more and k or less) or more of k conditions indicating a magnitude relationship between the finish date and time and the corrected finish date and time are satisfied.

Furthermore, the determination unit 112 assesses whether or not the finish date and time of each task (finish date and time included in the initial schedule) satisfies the following condition for the job JA.
Finish date and time of task TA1<corrected finish date and time T1
Finish date and time of task TA2<corrected finish date and time T2
Finish date and time of task TA3<corrected finish date and time T3

If all of the above three conditions are satisfied, the determination unit 112 assesses that the progress of the job JA is advanced, that is, the job JA can provide support. Note that the assessment as to whether the progress is advanced is not limited to the above method. For example, in a case where the number of tasks included in the job JA is k, the determination unit 112 may assess that the progress of the job JA is advanced when j (j is an integer of 1 or more and k or less) or more of k conditions indicating a magnitude relationship between the finish date and time and the corrected finish date and time are satisfied. The determination unit 112 may determine that the progress of the job JA is advanced when a condition that the finish date and time of the last task (a k-th task) is smaller than the corrected finish date and time is satisfied.

The determination unit 112 determines a support destination candidate and a support source candidate by using the progress assessed as described above. For example, the determination unit 112 determines a task whose progress is assessed to be delayed as a support destination candidate. In addition, the determination unit 112 determines a task whose progress is assessed to be advanced as a support source candidate.

Next, the generation unit 113 generates a candidate list by using the determined support destination candidates and support source candidates (step S103). The candidate list is, for example, a list of support candidates including the following elements.
Support source resources: resources allocated to tasks included in the support source candidates determined in step S102
Support destination candidates: support destination candidates determined in step S102
Start date and time: start date and time of support
Finish date and time: finish date and time of support

Each of the support candidates means that the support source resource supports the job including the support destination candidate from the start date and time to the finish date and time.

The start date and time and the finish date and time are determined as follows, for example, but may be determined by any other method.
Start date and time: start date and time when a support destination candidate (task whose progress is delayed) started
Finish date and time: corrected finish date and time of the support destination candidate (task whose progress is delayed)

The candidate list is generated to include, for example, support candidates corresponding to all combinations of the support source candidates and the support destination candidates determined in step S102. In a case where a plurality of at least one of the start date and time and the finish date and time is determined for one combination of the support source candidate and the support destination candidate, a plurality of support candidates for which a plurality of dates and times are further associated with the combination may be generated.

The support candidate does not need to be generated for all combinations of the support source candidate and the support destination candidate. For example, a support candidate corresponding to a combination limited according to a predetermined condition may be generated.

The condition may be a delay time condition and an advanced time condition. The delay time is calculated by, for example, “finish date and time-corrected finish date and time (finish date and time minus corrected finish date and time)” for a task whose progress is delayed. The advanced time is calculated by, for example, “corrected finish date and time-finish date and time” for the task for which the progress is advanced. The generation unit 113 uses the support destination candidate having the delay time larger than the threshold value for the generation of the support candidate. In addition, the generation unit 113 uses the support destination candidate having the advanced time larger than the threshold value for the generation of the support candidate.

The condition may be a condition on a capability of the resource. For example, the generation unit 113 confirms whether the ability (suitability) of the resource to provide support matches the task of the support destination. For example, if the type of task that can be processed indicated by the ability of the support source resource matches the type of task of the support destination candidate, the generation unit 113 generates a support candidate including a combination of the support source resource and the support destination candidate.

The generation unit 113 sorts the support candidates included in the candidate list in order of priority. The priority is set, for example, so as to increase as the delay of the support destination candidate increases and the progress of the task for which the support source resource is responsible increases. The priority setting method is not limited thereto, and other elements may be further considered. For example, the generation unit 113 may set the priority of the support candidate related to the specific job and the specific resource to be large or small. The generation unit 113 may set the priority according to the comparison result between at least one of the delay time and the advanced time and the threshold.

In the subsequent process, a process for obtaining an optimal changed schedule is executed using the sorted candidate list.

First, the allocation unit 114 selects an unprocessed support candidate from the candidate list in descending order of priority (step S104).

The allocation unit 114 executes an optimization process using the selected support candidate to generate a changed schedule (step S105). In the optimization process, the re-scheduling is performed assuming that the support source candidate can provide support, and the occupancy time (start date and time and finish date and time) of each task is determined. Details of the optimization process by the allocation unit 114 will be described later.

Next, it is assessed whether a delay will occur in the job including the support source candidate according to the generated changed schedule. Therefore, the calculation unit 111 calculates the corrected finish date and time for each task that is a support source candidate included in the generated changed schedule by using the correction information IA and IB (step S106).

The allocation unit 114 assesses whether or not a delay occurs in the job including the support source candidate by using the corrected finish date and time (Is there a delay in the job and the task of the support source?) (step S107). If a delay occurs (step S107: Yes), the allocation unit 114 returns to step S104, selects an unprocessed support candidate having the next highest priority from the candidate list, and repeats the process.

If no delay occurs (step S107: No), the allocation unit 114 determines the generated changed schedule as a schedule to be adopted (step S108).

The allocation unit 114 determines whether or not there is a delay in any task included in the changed schedule (step S109). For example, the allocation unit 114 calculates the corrected finish date and time for the tasks of all the jobs in a procedure similar to step S106, and assesses whether or not a delay occurs for the tasks of all the jobs using the calculated corrected finish date and time. If there is a delay (step S109: Yes), the allocation unit 114 returns to step S104, selects an unprocessed support candidate having the next highest priority from the candidate list, and repeats the process. In a case where there is no delay (step S109: No), the re-scheduling process ends.

Next, details of the optimization process by the allocation unit 114 will be described.

The allocation unit 114 executes the optimization process for the purpose of calculating optimum allocation that minimizes the finish date and time of the entire job among combinations of each task and resource of each job. In the optimization process, the following plurality of conditions (C1) to (C4) are considered.

### (C1) Combination of Task and Resource

The optimal resource allocation for the task is calculated such that the finish date and time of each job is minimized.

### (C2) Minimization of Finish Date and Time of Task

It is also possible to minimize the finish date and time for each task. In addition, it is possible to minimize the finish date and time in a case where a plurality of jobs having the same task is bundled.

### (C3) Different Processing Time for Each Resource

The processing time of each task may be different for each resource. The optimal allocation according to the processing time of the task different for each resource can be performed.

### (C4) Consideration of Set-Up Time Between Consecutive Tasks

A set-up time (such as a movement time) can also be considered between successive tasks. As a result, more realistic scheduling is realized.

In order to satisfy the above conditions, the allocation unit 114 calculates the optimal resource allocation using mathematical formulation as described below. The following formula is an example of a mixed integer linear programming (MILP) for solving this problem.

### (1) Decision Variable

1. x_{i,j,k}∈{0, 1}: a binary variable indicating whether or not a task i is allocated to a resource j and starts at time k. 1 represents being allocated, and 0 represents not being allocated.
2. Cᵢ: Finish date and time of the task i (time)
3. Sᵢ: Start date and time of task i (time)
4. T_{i,j}: Processing time of task i allocated to resource j

### (2) Objective Function

An objective function that minimizes the finish date and time of the task is expressed by the following Expression (1).

$$min {\sum }_{i ∈ Task} {C}_{i} \qquad ( 1 )$$

To minimize the finish date and time when a plurality of jobs is bundled, the maximum finish date and time Cₘₐₓ of the entire job may be minimized using an objective function represented by the following Expression (2).

$$min {C}_{max} , {C}_{max} \geq {C}_{i} , ∀ i ∈ Task \qquad ( 2 )$$

### (3) Constraint Condition

1. Resource allocation constraint: A constraint indicating that each task is allocated to one resource, and is expressed by the following Formula (3).

$${\sum }_{j ∈ Resource} {\sum }_{k ∈ Time} {x}_{i , j , k} = 1 , ∀ i ∈ Task \qquad ( 3 )$$

that the finish date and time of the task is the sum of the start date and time and the processing time, and is expressed by the following Formula (4).

$${C}_{i} = {S}_{i} + {T}_{i , j} , ∀ i ∈ Task , ∀ j ∈ Resource \qquad ( 4 )$$

3. Resource availability time constraint: A constraint indicating that the same resource cannot process a plurality of tasks at the same time, and is expressed by the following Expression (5).

$${S}_{i} + {T}_{i , j} \leq {S}_{{i}^{′}} ∀ ( i , {i}^{′} ) ∈ Consecutive tasks in the same resource \qquad ( 5 )$$

4. Set-up time (movement time or the like) constraint: A constraint indicating that a set-up time δ_{i, i′} exists between consecutive tasks, and is expressed by the following Expression (6).

$${S}_{{i}^{′}} \geq {C}_{i} + {δ}_{i , {i}^{′}} ∀ ( i , {i}^{′} ) ∈ Consecutive tasks \qquad ( 6 )$$

indicating that for a plurality of tasks belonging to the same job, the finish date and time of the job is the maximum value of the finish dates and times of all the tasks, and is expressed by the following Expression (7).

$${C}_{Job} \geq {C}_{i} ∀ i ∈ Tasks belonging to job \qquad ( 7 )$$

Formulas (3) to Expression (5) correspond to the constraint assuming that the support source candidate can provide support.

The allocation unit 114 obtains an optimal resource allocation by the MILP solver using the above-described constraint conditions and objective function. The MILP solver may be any solver, and for example, solving constraint integer programs (SCIP) and Gurobi can be used.

Based on the allocation result by the optimization process, the tasks of each job can be processed in the optimal order and resources, and the finish date and time of the entire job can be minimized.

The allocation unit 114 can not only minimize the finish date and time for each task but also optimize the entire finish date and time by bundling a plurality of jobs having the same task. Furthermore, a more realistic schedule can be provided by considering processing time different for each resource and set-up time between consecutive tasks.

The initial schedule is, for example, a schedule generated in advance before work corresponding to a job is actually started. The initial schedule may be a schedule to be re-scheduled according to the progress of work after the work is started. For example, at a certain time point (hereinafter, time point PA) after the start of the work according to the initial schedule or the changed schedule obtained by the method of the present embodiment, the re-scheduling may be executed with the schedule after the time point PA as the initial schedule.

In this case, the method of the above embodiment is applied by using a schedule after the time point PA as an initial schedule. This enables generating a flexibly changed schedule such that support can be started and finished even in units of a task and in the middle of the task. That is, the support can be started or finished at an appropriate timing according to the progress of the job, and a changed schedule can be generated that enables maximally improving the overall progress of the job.

Next, an example of a method of calculating the correction information (correction information IA and IB) will be described. It is desirable that the correction information is appropriately set in order to generate an efficient changed schedule based on priorities of jobs, tasks, and resources. The correction information is set to a value corresponding to the priority of each job, task, and resource, and is used for determination of availability and timing of support.

As described above, the correction information is defined for each of the plurality of jobs. Therefore, the correction information may be set according to the priority of each job. The priority of the job is determined, for example, based on the progress status of the job and relative importance with respect to other jobs. For example, when the priority of the job is high, the value of the correction information IA of the job is increased, and the value of the correction information IB is decreased. This makes it possible to quickly allocate resources to the job with the high priority and accelerate the progress.

Next, the function of the adjustment unit 115 that adjusts the correction information will be described in detail. The adjustment unit 115 is a function for dynamically adjusting the correction information according to the progress of the job, the operating status of the resource, and the like. As a result, appropriate support is performed for the task that requires support, and the overall progress can be optimized.

For example, when a work instruction at the site is issued with reference to the changed schedule generated by the method of the present embodiment, the adjustment unit 115 adjusts the correction information by comparing the changed schedule with the work instruction (schedule adopted based on the changed schedule).

For example, the adjustment unit 115 compares the number of times of support in the changed schedule with the number of times of actual support instructions. In the case that the number of times of support in the changed schedule is larger, the adjustment unit 115 increases the value of correction information IA or decreases the value of correction information IB to facilitate the support. In the case that the number of times of support in the changed schedule is smaller, the adjustment unit 115 decreases the value of correction information IA or increases the value of correction information IB to make it harder for support. In this case, the correction information of all the jobs is to be adjusted.

As another example, in a case where the work instruction at the site is issued according to the changed schedule generated by the method of the present embodiment, the adjustment unit 115 may adjust the correction information based on the actual progress status of the job (task).

For example, when the progress of the job (task) advances from the changed schedule, the adjustment unit 115 reduces the number of times of support by decreasing the value of the correction information IA or increasing the value of the correction information IB. When the progress of the job (task) is delayed from the changed schedule, the adjustment unit 115 increases the number of times of support by increasing the value of the correction information IA or decreasing the value of the correction information IB.

As described above, the adjustment unit 115 uses performance data (the number of work instructions, progress status, and the like) for a certain period. Therefore, when the correction information is adjusted by the adjustment unit 115, for example, the acquisition unit 101 acquires the actual data for a certain period.

The certain period may be defined in any manner, and is, for example, a period defined as follows.
Period of several months: Adjustments can be made according to busy-period, slow-period, and seasonal trend and the like.
Shift unit or period of several hours unit in one day: Correction information can be adjusted frequently in one day.

### Modification

Examples of using the correction information defined for each job has been described above. Correction information defined for each task may be further used. Hereinafter, a modification using correction information defined for each task (hereinafter, correction information IC) will be described.

The correction information IC for each task is set according to the priority of the task, for example. For example, as the priority is higher, a larger value is set to the correction information IC. The correction information IC is used to calculate the corrected finish date and time. For example, the calculation unit 111 calculates the corrected finish date and time such that as the correction information IC (priority) gets larger, the support is more likely to be received.

Similarly to FIG. 3, an example of three tasks TA1 to TA3 included in the job JA will be described. The correction information IC of the tasks TA1, TA2, and TA3 are represented as correction information IC1, IC2, and IC3. For example, instead of using the scheduled finish dates and times S1, S2, and S3 as they are, the calculation unit 111 calculates the corrected finish date and time by multiplying the scheduled finish dates and times S1, S2, and S3 by a coefficient that decreases as the value of the correction information IC increases. The coefficient may be, for example, a reciprocal of the correction information IC. For example, the calculation unit 111 calculates the corrected finish date and time as follows.
T1:T2:T3=S1/IC1:S2/IC2:S3/IC3

Next, a method of setting the priority of the task will be described. The priority of a task is set based on, for example, an influence of the task on the entire job and a dependency relationship with another task.

The priority of the task is determined according to the resource allocated in the initial schedule. For example, the priority of the task is determined based on the number of resources allocated in the initial schedule. A task having many allocated resources can more easily provide (support) the allocated resources to other tasks. Therefore, the priority of the task is set low. As a result, the value of the correction information IC of the task becomes small, and it becomes difficult to receive support. A task having a small number of allocated resources is set to have a high priority. As a result, the value of the correction information IC of the task becomes large, and it becomes easy to receive support.

The priority of the task may be determined based on the capability information of the resource. For example, in a case where the resource has many capabilities, the priority of the task to which the resource is allocated is set low. In a case where the resource has less capabilities (specialized for a specific ability), the priority of the task to which the resource is allocated is set high. As a result, a task for which the allocated resource is specialized in a specific capability can be preferentially supported.

As described above, in the information processing apparatus according to the embodiment, the changed schedule for which the initial schedule is changed can be generated by using the correction information indicating easiness of support. As a result, the re-scheduling for changing the generated schedule can be executed more efficiently.

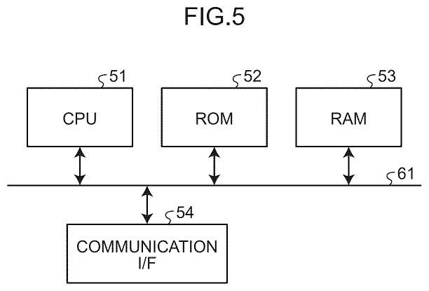

Next, a hardware configuration of the information processing apparatus according to the embodiment will be described with reference to FIG. 5. FIG. 5 is a diagram illustrating a hardware configuration example of the information processing apparatus according to the embodiment.

The information processing apparatus according to the embodiment includes a control device such as a central processing unit (CPU) 51, a storage device such as a read only memory (ROM) 52 and a random access memory (RAM) 53, a communication I/F 54 that is connected to a network and performs communication, and a bus 61 that connects the respective units.

The program executed by the information processing apparatus according to the embodiment is provided by being incorporated in the ROM 52 or the like in advance.

The program executed by the information processing apparatus according to the embodiment may be provided as a computer program product by being recorded as a file in an installable format or an executable format in a computer-readable recording medium such as a compact disk read only memory (CD-ROM), a flexible disk (FD), a compact disk recordable (CD-R), or a digital versatile disk (DVD).

Furthermore, the program executed by the information processing apparatus according to the embodiment may be stored on a computer connected to a network such as the Internet and provided by being downloaded via the network. Furthermore, the program executed by the information processing apparatus according to the embodiment may be provided or distributed via a network such as the Internet.

The program executed by the information processing apparatus according to the embodiment can cause a computer to function as each unit of the information processing apparatus described above. In this computer, the CPU 51 can read a program from a computer-readable storage medium onto a main storage device and execute the program.

A configuration example of the embodiments will be described below.

Configuration Example 1. According to an embodiment, an information processing apparatus includes at least one hardware processor. The hardware processor is configured to calculate, for an initial schedule including a resource to be allocated to each of one or more tasks included in each of a plurality of jobs and a finish date and time of each of the one or more tasks, a corrected finish date and time obtained by correcting the finish date and time by using one or more pieces of correction information defined for each of the plurality of jobs. The hardware processor is configured to determine, by using the corrected finish date and time, a provision destination candidate that is a candidate for a task of receiving provision of a resource from a task included in another job and a provision source candidate that is a candidate for a task of providing a resource to a task included in another job. The hardware processor is configured to generate a provision candidate including a provision source resource that is a resource allocated to the provision source candidate and the provision destination candidate. The hardware processor is configured to generate a changed schedule for which the initial schedule is changed by optimizing resource allocation to the one or more tasks included in each of the plurality of jobs by using the provision candidate.

Configuration Example 2. In the information processing apparatus according to example 1, the correction information includes first correction information and second correction information. Where, the first correction information is defined such that a larger value is more likely to receive provision of a resource, and the second correction information is defined such that a smaller value is more likely to provide a resource. The hardware processor is configured to calculate a first corrected finish date and time when provision of the resource is assumed to be received and a second corrected finish date and time when the resource is assumed to be provided. The first corrected finish date and time is the corrected finish date and time obtained by correcting the finish date and time using the first correction information, and the second corrected finish date and time is the corrected finish date and time obtained by correcting the finish date and time using the second correction information. The hardware processor is configured to determine the provision destination candidate by comparing the finish date and time with the first corrected finish date and time. The hardware processor is configured to determine the provision source candidate by comparing the finish date and time with the second corrected finish date and time.

Configuration Example 3. In the information processing apparatus according to example 1, the initial schedule includes a closing date and time that is a finish date and time of each of the plurality of jobs. The hardware processor is configured to calculate a corrected closing date and time obtained by correcting the closing date and time with the correction information; and calculate the corrected finish date and time such that the one or more tasks finish by the corrected closing date and time.

Configuration Example 4. In the information processing apparatus according to example 3, the hardware processor is configured to calculate the corrected finish date and time such that a ratio of a scheduled finish date and time defined for each of the one or more tasks matches a ratio of the corrected finish date and time of each of the one or more tasks.

Configuration Example 5. In the information processing apparatus according to example 1, the hardware processor is configured to optimize an allocation of a resource to the one or more tasks included in each of the plurality of jobs so as to minimize a finish date and time of each of the plurality of jobs.

Configuration Example 6. In the information processing apparatus according to example 1, the hardware processor is configured to adjust the correction information based on a comparison result between the changed schedule and a schedule adopted based on the changed schedule.

Configuration Example 7. In the information processing apparatus according to example 1, the hardware processor is configured to calculate the corrected finish date and time by further using correction information defined for each of the one or more tasks.

Configuration Example 8. According to an embodiment, an information processing method is executed by at least one hardware processor of a computer of an information processing apparatus. The method includes calculating, for an initial schedule including a resource to be allocated to each of one or more tasks included in each of a plurality of jobs and a finish date and time of each of the one or more tasks, a corrected finish date and time obtained by correcting the finish date and time by using one or more pieces of correction information defined for each of the plurality of jobs; determining, by using the corrected finish date and time, a provision destination candidate that is a candidate for a task of receiving provision of a resource from a task included in another job and a provision source candidate that is a candidate for a task of providing a resource to a task included in another job; generating a provision candidate including a provision source resource that is a resource allocated to the provision source candidate and the provision destination candidate; and generating a changed schedule for which the initial schedule is changed by optimizing resource allocation to the one or more tasks included in each of the plurality of jobs by using the provision candidate.

Configuration Example 9. According to an embodiment, a computer program product has a non-transitory computer readable medium including instructions stored thereon. When executed by a computer, the instructions cause the computer to execute calculating, for an initial schedule including a resource to be allocated to each of one or more tasks included in each of a plurality of jobs and a finish date and time of each of the one or more tasks, a corrected finish date and time obtained by correcting the finish date and time by using one or more pieces of correction information defined for each of the plurality of jobs; determining, by using the corrected finish date and time, a provision destination candidate that is a candidate for a task of receiving provision of a resource from a task included in another job and a provision source candidate that is a candidate for a task of providing a resource to a task included in another job; generating a provision candidate including a provision source resource that is a resource allocated to the provision source candidate and the provision destination candidate; and generating a changed schedule for which the initial schedule is changed by optimizing resource allocation to the one or more tasks included in each of the plurality of jobs by using the provision candidate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
at least one hardware processor configured to:
calculate, for an initial schedule including a resource to be allocated to each of one or more tasks included in each of a plurality of jobs and a finish date and time of each of the one or more tasks, a corrected finish date and time obtained by correcting the finish date and time by using one or more pieces of correction information defined for each of the plurality of jobs;
determine, by using the corrected finish date and time, a provision destination candidate that is a candidate for a task of receiving provision of a resource from a task included in another job and a provision source candidate that is a candidate for a task of providing a resource to a task included in another job;
generate a provision candidate including a provision source resource that is a resource allocated to the provision source candidate and the provision destination candidate; and
generate a changed schedule for which the initial schedule is changed by optimizing resource allocation to the one or more tasks included in each of the plurality of jobs by using the provision candidate.

2. The information processing apparatus according to claim 1, wherein
the correction information includes first correction information and second correction information, the first correction information being defined such that a larger value is more likely to receive provision of a resource, the second correction information being defined such that a smaller value is more likely to provide a resource, and
the hardware processor is configured to:
calculate a first corrected finish date and time when provision of the resource is assumed to be received and a second corrected finish date and time when the resource is assumed to be provided, the first corrected finish date and time being the corrected finish date and time obtained by correcting the finish date and time using the first correction information, the second corrected finish date and time being the corrected finish date and time obtained by correcting the finish date and time using the second correction information;
determine the provision destination candidate by comparing the finish date and time with the first corrected finish date and time; and
determine the provision source candidate by comparing the finish date and time with the second corrected finish date and time.

3. The information processing apparatus according to claim 1, wherein
the initial schedule includes a closing date and time that is a finish date and time of each of the plurality of jobs, and
the hardware processor is configured to:
calculate a corrected closing date and time obtained by correcting the closing date and time with the correction information; and
calculate the corrected finish date and time such that the one or more tasks finish by the corrected closing date and time.

4. The information processing apparatus according to claim 3, wherein
the hardware processor is configured to:
calculate the corrected finish date and time such that a ratio of a scheduled finish date and time defined for each of the one or more tasks matches a ratio of the corrected finish date and time of each of the one or more tasks.

5. The information processing apparatus according to claim 1, wherein
the hardware processor is configured to:
optimize an allocation of a resource to the one or more tasks included in each of the plurality of jobs so as to minimize a finish date and time of each of the plurality of jobs.

6. The information processing apparatus according to claim 1, wherein
the hardware processor is configured to:
adjust the correction information based on a comparison result between the changed schedule and a schedule adopted based on the changed schedule.

7. The information processing apparatus according to claim 1, wherein
the hardware processor is configured to:
calculate the corrected finish date and time by further using correction information defined for each of the one or more tasks.

8. An information processing method executed by a computer of an information processing apparatus, the method comprising:
calculating, for an initial schedule including a resource to be allocated to each of one or more tasks included in each of a plurality of jobs and a finish date and time of each of the one or more tasks, a corrected finish date and time obtained by correcting the finish date and time by using one or more pieces of correction information defined for each of the plurality of jobs;
determining, by using the corrected finish date and time, a provision destination candidate that is a candidate for a task of receiving provision of a resource from a task included in another job and a provision source candidate that is a candidate for a task of providing a resource to a task included in another job;
generating a provision candidate including a provision source resource that is a resource allocated to the provision source candidate and the provision destination candidate; and
generating a changed schedule for which the initial schedule is changed by optimizing resource allocation to the one or more tasks included in each of the plurality of jobs by using the provision candidate.

9. A computer program product having a non-transitory computer readable medium including instructions stored thereon, wherein the instructions, when executed by a computer, cause the computer to execute:
calculating, for an initial schedule including a resource to be allocated to each of one or more tasks included in each of a plurality of jobs and a finish date and time of each of the one or more tasks, a corrected finish date and time obtained by correcting the finish date and time by using one or more pieces of correction information defined for each of the plurality of jobs;
determining, by using the corrected finish date and time, a provision destination candidate that is a candidate for a task of receiving provision of a resource from a task included in another job and a provision source candidate that is a candidate for a task of providing a resource to a task included in another job;
generating a provision candidate including a provision source resource that is a resource allocated to the provision source candidate and the provision destination candidate; and
generating a changed schedule for which the initial schedule is changed by optimizing resource allocation to the one or more tasks included in each of the plurality of jobs by using the provision candidate.
